(19) United States
(12) Patent Application Publication
(10) Pub. No.: US 2010/0155635 A1
(43) Pub. Date: Jun. 24, 2010

(54) Systems & Methods For Monitoring And Controlling Water Consumption

(76) Inventor: Giovanni Fima, Oceanside, CA (US)

Correspondence Address: FISH & ASSOCIATES, PC;ROBERT D. FISH, 2603 Main Street, Suite 1000, Irvine, CA, 92614-6232, US

(21) Appl. No.: 12/640,225

(22) Filed: Dec. 17, 2009

Related U.S. Application Data
(60) Provisional application No. 61/139,775, filed on Dec. 22, 2008.

(51) Int. Cl. F16K 31/02; B23P 23/00

(52) U.S. Cl. 251/129.01; 137/552; 29/401.1

(57) ABSTRACT

Systems that utilize a power grid to monitor and control fluid flow within a water system are presented. The system can have first and second docking stations configured to process signals produced by respective first and second sensors. The docking stations are preferably user-pluggable into a power grid such that the docking stations can communicate with other docking stations, sensors, or a remote monitor. Methods of refitting an existing water system to monitor and control water consumption are also presented. Sections of the existing system can be replaced with new sections that include at least one valve and sensor to monitor and control fluid flow through that section.

This application claims the benefit of priority to U.S. provisional application having Ser. No. 61/139,775 filed on Dec. 22, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is valve controllers.

### BACKGROUND

There are two main reasons for fluid leaks or other undesired fluid flow in a water system. The first is that plumbing is typically an open system. The second is that once a leak has begun, it often continues with devastating results. Fluid leaks, and particularly water leaks, can cause a significant amount of structural damage and health issues from resulting mold. In a major study of water leaks by FluidMaster (CA), the results indicated that 80% are caused by toilets, with 94% of all leaks occurring between the manual shut-off valve and the flexible line to the appliance. This stretch of plumbing is typically the weakest link in a water system and is prone to malfunction and rupture.

One solution to prevent water leaks involves placing at least one sensor beneath an appliance, such as a washing machine. Should a leak develop with the appliance or the line connecting the appliance to the building's water system, the sensor will detect the liquid beneath the appliance and communicate with a receiver. The receiver could then create a visual alert, sound an alarm, or shut off the water supply to the appliance. One problem is that the sensors often deteriorate (e.g., oxidize, corrode) over time and can become non-functional. Another problem is that the sensors typically have false alarms. For example, mopping the floor might cause some water to touch the sensor, which would trigger the alert or shut off the water supply.

To help prevent corrosion and false alarms, sensors have been built-in to plumbing systems. For example, U.S. Pat. Nos. 7,306,008 to Tornay and 5,441,070 to Thompson discuss water systems that close the main valve to a structure when the water system is not in use. These systems monitor water flow within a structure using flow sensor disposed between the manual shut-off and the line leading to the water outlet (e.g., a sink, a washing machine, a toilet, etc.). When water flow is detected, the system opens the main valve to allow water flow within the structure. Thus, the main shut-off valve to a structure remains closed until an occupant within the home requires water flow. One problem with these systems is that water flows to the entire structure whenever any portion of the structure requires water flow. Another problem is that such systems are typically not user-installable, but require a trained electrician and/or plumber for installation.

U.S. Pat. No. 5,347,264 to Bjorkman and U.S. Pat. No. 6,691,724 to Ford attempt to overcome the above-mentioned problems by using systems that detect the presence of occupants within one or more areas of a household, and control the supply of water to those areas. These systems provide that water from the main inlet can be selectively controlled to flow only to designated areas of a household. Thus, for example, a leak in one area of a household will not deny the use of water in other areas of the same household. However, these systems are also not user-installable, and require a trained electrician and/or plumber for installation. In addition, these systems fail to prevent leaks while occupants are present.

In a further attempt to alleviate the problems described above, U.S. Pat. No. 6,895,788 to Montgomery discusses a kit for an appliance having a valve, a control unit plugged into a wall outlet. The control unit includes a built-in outlet into which the appliance is plugged. When the control unit detects current flow to the outlet, the control unit opens the valve. One problem with this configuration is that the kit can only sense current flow to appliances and thus has limited applicability in detecting leaks. A further problem is that the kit lacks any capability for remote monitoring of the sensor signal.

Thus, there is still a need for systems and methods for preventing leaks or other undesired fluid flow that have a user-pluggable power connector and the capability for remote monitoring.

### SUMMARY OF THE INVENTION

The inventive subject matter provides systems and methods in which a power grid is used to facilitate data transfer and control of a valve. The system has at least a first and second sensor, as well as at least a first and second networked docking station. Unless a contrary intent is apparent from the context, all ranges recited herein are inclusive of their endpoints, and open-ended ranges should be interpreted to include only commercially practical values. The first and second sensors output first and second signals, respectively, and each docking station can have electronics that process signals produced by one or more sensors. Thus, for example, the first and second docking stations can be configured to process the first and second signals received from the first and second sensors, respectively.

The system could be used in any building having a water supply system, and preferably is used in buildings having many units that are individually occupied (e.g., independently billable units with different occupants/owners) including, for example, offices, apartments, and condominiums. Still more preferably, the systems can be installed in commercial buildings and high rises, although such system can also be used in single-family homes. Within each building or unit, sensors can be placed in a variety of locations, and preferably are placed at locations near where water exits the water system (e.g., HVAC, irrigation, sinks, showers, washing machines, etc.).

In especially preferred embodiments, the systems could be used to monitor and regulate water flow to a water heater, boiler, or other pressure vessel. For example, a flow sensor could be placed on both the inlet and outlet pipes to the water heater. One or more docking stations could be used with the sensors to monitor the flow into and out from the water heater. In this manner, the system could detect any change in water flow and determine if a leak or other undesired fluid flow is present. This is advantageous as the system can therefore detect any undesired fluid flow before it can become a serious problem, and can eliminate the need for, and the problems associated with, external wet sensors.

In some contemplated embodiments, the system could be used to regulate a flow of at least one of gas and electric current that provides energy to the water heater. In other contemplated embodiments, the system could be used with an irrigation system, such as by measuring (a) the duration of a fluid flow or (b) the amount of fluid flow at each valve. In this manner, the amount of water flowing from the irrigation system could be limited to thereby prevent flooding or other wastes of water.

The sensors preferably include at least one of flow, temperature and pressure sensors, depending on the applications. It is contemplated that two or more sensors could be used to provide additional information to a single docking station. The sensors can be physically separated and placed throughout a building where monitoring is desired. As used herein, “physically separated” means a physical distance of at least two feet between the sensors. Preferably, each the sensors can be placed within a valve, or adjacent to a valve (e.g., within twelve inches), although other distances are also contemplated.

The system can further include a motion sensor, and the first docking station can have electronics enabling the docking station to process signals from the motion sensor. In this manner, the presence of occupants can be monitored to optionally shut-off the valves when no person is present to help prevent undesired fluid flow in an unoccupied home or structure.

All commercially suitable types of valves are contemplated for use in the system to regulate fluid flow including for example, needle valves, ball valves, gate valves, poppet valves, plug valves, globe valves, butterfly valves, and diaphragm valves. However, this does not include non-fluid “valves” such as diodes. Contemplated valves can regulate flow in one or more directions using any commercially suitable design including for example, a straight-through, a two-way, and a three-way design. In addition to being manually controlled, it is preferred that the valves include electronic actuators configured to electrically control the valves. This is advantageous as the valves could be controlled automatically by one or more valve actuators, but could also be manually controlled if needed (e.g., due to a malfunctioning docking station or a power outage). Contemplated valves could be part of the existing water system or alternatively be installed with the sensor. Preferably, the valves have a closed bias (e.g., default to a closed position).

The docking station can include electronics configured to receive a signal from one or more sensors, and control one or more electronically actuated valves, such as those described above. The docking station can also include a plug that is sized and dimensioned to be received into a standard power outlet. Although the docking station is preferably located at or near the power outlet, other locations are also contemplated.

Contemplated docking stations can be connected to one or more valves sensors using a wireless connection (e.g., WIFI, Bluetooth, GSM, wireless USB, infrared, radio frequency or telemetry), a wired connection (e.g., one or more cables or other wires providing both power and data connections), or any combination(s) thereof. It is especially preferred that each docking station can be independently operable with respect to the other docking stations. For example, a docking station could be configured to independently monitor one or more sensors, and control a valve or its related valve actuator. In addition, the docking station could be used to control two or more valves, which is especially advantageous when the valves are closely situated, such as a sink having a valve for each of the hot and cold water inlets.

The docking station can also have a display for displaying sensor information and other data. In addition, the docking station can have a speaker or one or more lights to indicate the docking station's status or alert a user to a problem with the valve, docking station, or sensor, for example. Thus, the speakers or lights could warn of a potential leaks or other problem with the pipes or conduits, a lack of power (e.g., a power outage or the docking station becoming unplugged), a low battery, and so forth. Contemplated docking stations can each have memory to store sensor and other information, as well as electronics that allow the docking stations to communicate with a remote monitor such as the touch screen OmniBreaker panel, manufactured by LiquidBreaker LLC located in Carlsbad, Calif. This is advantageous as the remote monitor can allow information from the docking station to be downloaded to the remote monitor (e.g., portable computers, cellular phones, dedicated panels, etc.), and the remote monitor could configure each docking station as needed to match the functionality of a specific appliance. For example, the docking station could be configured to sense a current flow from a dishwasher and have a timer such that the docking station shuts off a water flow to the dishwasher after the dishwasher's cycle is completed.

The docking station, the remote monitor, or a separate power module coupled to the docking station can have circuitry to control the valve should a loss of power occur (e.g., a power outage or a lack of sufficient power to operate the docking station). For example, the docking station or module could be configured to open the valve when it detects a lack of power. This is advantageous as it allows access to water during a power outage. This is especially important in a system that closes the valves when water is not in use, as a power outage would require each valve to be manually opened for water flow.

In addition, the docking station can have circuitry configured to provide a time delay capability. Preferably, this capability can be used in combination with the motion sensor described above. In this manner, the docking station can allow the valve to remain open for a defined period of time once motion is no longer detected, and after which the docking station would close the valve. As used herein, the docking station could close the valve directly, or indirectly, such as by communicating with a valve actuator coupled to the valve. The time delay can be any practical period of time, and preferably is of at least one minute. More preferably, the time delay can be configured and changed as needed to best conform to the need for the water. For example, a time delay of one minute might be sufficient for a sink, but a time delay of thirty minutes might be needed for a dish washer.

In some contemplated embodiments, at least one and preferably all of the sensors, valve actuators, and docking stations can be battery-powered. Additionally or alternatively, the docking stations can be user-pluggable into a power grid. For example, the docking stations could include a connector that is sized and dimensioned to be inserted into a standard outlet (e.g., a NEMA 1-15 connector). This is advantageous as it eliminates the need for an electrician by using existing power outlets. Once plugged in, the docking stations can provide power to sensors, charge a battery supply, and electrically actuated valves or valve actuators coupled to the docking station. In addition, the docking station could have electronics configured to convert the standard voltage from the power grid into multiple voltages depending on the needs of the sensors and valves. This is beneficial as it allows the docking station to power a broader range of sensors and valve actuators that might be used or already installed. Thus, once the docking stations are plugged into the power grid, varying voltages can be distributed to the components of the system, as necessary.

Plugging the docking station into a power grid allows the docking station to be networked with other docking stations plugged into the grid, as well as remote monitors such as the touch screen Omnibreaker panel manufactured by LiquidBreaker of Carlsbad, Calif. In this manner, the docking stations could communicate signals from the sensors or processed information to the monitor or other docking stations. To utilize such a network, the docking stations and the monitor preferably have a network interface configured for an IP over power line connection, utilize coupled X10 modules, or have other commercially suitable electronics. In addition, wireless connections are also contemplated. In this manner, no additional wiring is needed to allow for monitoring or controlling the system from the remote monitor. For example, by networking the docking stations with the remote monitor, any valves or valve actuators coupled to the docking stations could be controlled remotely by the monitor. Furthermore, information received from the docking stations can be used to determine the location of potential or actual problems in the water system.

While a remote monitor might have limited necessity in a single-family home, the monitor can provide many advantages in commercial high-rises or other buildings with a plurality of units. For example, the monitor could allow near real-time visual or audible information of the water system's use, including fluid flow, pressures, and temperatures in the system. Should any problem be reported, the monitor could not only remotely command a valve actuator to close a valve, but could report the physical location of the problem so that maintenance can be performed before the problem grows.

In some contemplated embodiments, the networked docking stations can utilize a router, modem, or other Intranet or Internet gateway to allow for sending or receiving information from the docking stations to a remote location. This is advantageous as it allows information from the docking stations to be accessed remotely from the building. For example, a home owner could monitor the water system away from the home, and remotely open or close a valve as desired.

In one aspect, a water system can be retrofitted to reduce the risk of water leaks or other undesired fluid flow. At least two sections of the water system can be replaced with sections that can each include at least one sensor having the capability to measure at least one of flow, temperature and pressure in the section. Once installed, information from the sensors can be monitored over the power line, and if desired, a valve actuator can be controlled to shut off water flow through a first valve included in at least one of the replacement sections.

The existing section of the system to be replaced might or might not have a valve. While each replacement section can have at least one valve with at least one sensor, preferred replacement sections have two or more valves such as for hot and cold water, and/or two or more sensors. In addition, the sensors in the replacement section can be located within the valve itself or adjacent to the valve (e.g., within twelve inches). This is advantageous, as the replacement section could be restricted in size due to the space limitations of the section replaced.

Information from at least one of the sensors could be monitored by a central monitor. Preferably, the monitor is networked to the actuator using a power line, such as through the use of an IP over power connection. Such connection could also be used to network the docking stations and sensors.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1a is a schematic of one embodiments of a water system having first and second docking stations.

FIGS. 1b and 1c are enlarged portions of the schematic of FIG. 1a.

FIGS. 2 and 3 are front and rear perspective views, respectively, of one embodiment of a docking station.

FIG. 4 is a front perspective view of another embodiment of a docking station.

FIG. 5 is a diagram of another embodiment of a water system having a docking station and a remote monitor

FIG. 6 is a flowchart of a method to retrofit an existing water system to monitor and control water consumption.

### DETAILED DESCRIPTION

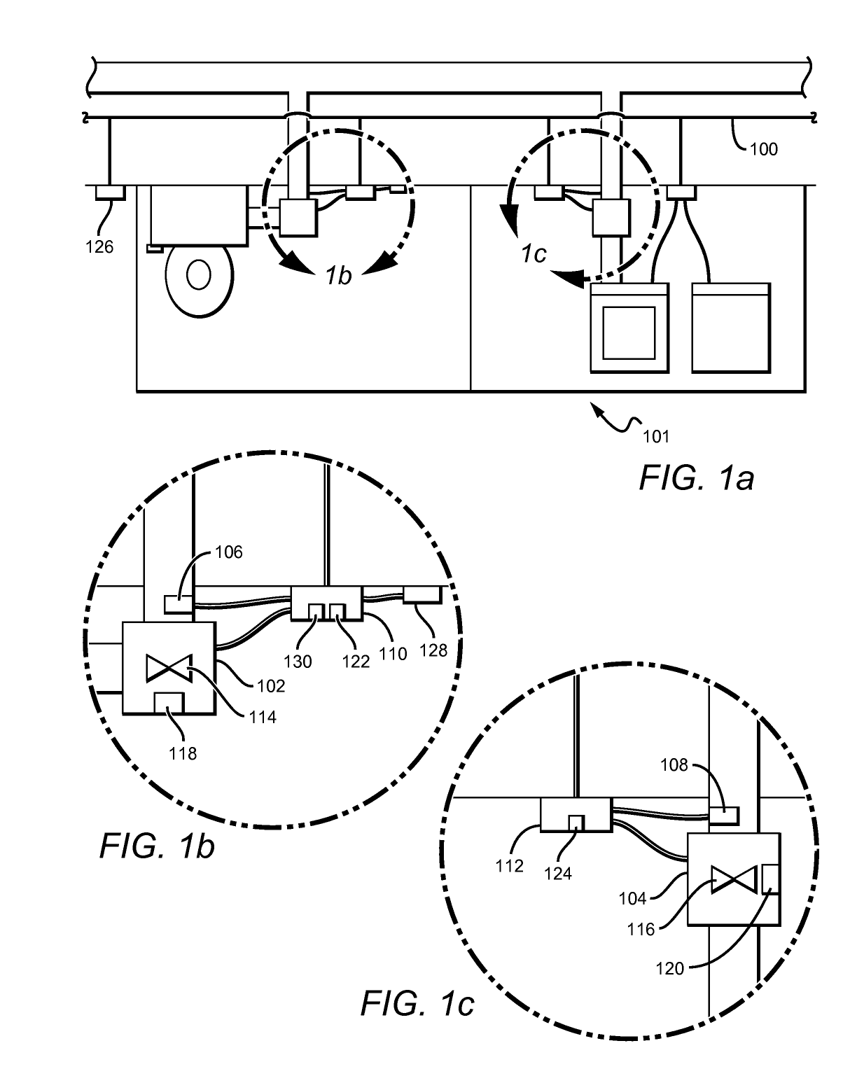

In FIG. 1, a system 101 is illustrated that uses a power grid 100 to control first 102 and second fluid valves 104, while powering the various components in system 101. System 101 includes first 106 and second sensors 108 as well as first 110 and second networked docking stations 112.

First 102 and second valves 104 are preferably ball valves, although any commercially suitable valves for regulating fluid flow are contemplated including for example, needle valves, gate valves, poppet valves, plug valves, globe valves, butterfly valves, and diaphragm valves. In addition to manual controls 114 and 116, first and second electronic actuators 118 and 120 can be coupled to respective first 102 and second valves 104 that allow the valves to be automatically controlled. In some contemplated embodiments, the electronic actuators can be disposed within the valve housing. Manual controls can be provided, such controls are optional. Either or both of first and second valves 102 and 104 could be part of an existing water system or retrofitted to the water system. Preferably, such valves can have a closed bias (e.g., default to a closed position) to prevent the flow of water when not needed and thereby help reduce leaks or other undesired fluid flow.

First 106 and second sensors 108 can be physically separated and function to monitor a fluid parameter and transmit a signal. Such parameters can include, for example, fluid flow, pressure and temperature. It is contemplated that any number of sensors can be used in system 101. While FIG. 1 shows first 106 and second sensors 108 located adjacent to first 102 and second valves 104 (e.g., within twelve inches), it is contemplated that at least one of the first and second sensors 106 and 108 can be placed within the valve. For example, the sensor can be built-in to the valve. This is advantageous as it reduces the total space occupied by the valve and sensor.

In addition to first and second sensors 106 and 108, the system 101 can optionally include motion sensor 128 that can output a third signal in response to the presence of occupants in the area. The first docking station 110 can have electronics 130 configured to process the information produced by the motion sensor 128.

As shown in FIG. 1, first 110 and second networked docking stations 112 can be coupled to the first 102 and second valves 104 as part of a permanently installed water system. While preferably a wired connection can be used to couple the docking stations 110 and 112 to the valves, it is contemplated that at least one of the docking stations 110 and 112 can communicate with at least one of the sensors 106 and 108 using a wireless connection, including those described above. First and second docking stations 110 and 112 can be configured to electronically control first and second valves 102 and 104 by way of first and second electronic actuators 118 and 120, respectively. Preferably, the first and second docking stations 110 and 112 can have electronics (not shown) configured to vary the voltage and current outputted by the docking stations to the one or more valves. In this manner, the docking stations 110 and 112 can receive signals from the sensors 106 and 108, and open or close the valves as needed. At least the first docking station 110 can be further configured to process the third signal received from motion sensor 128. In an alternate embodiment, at least the first docking station 110 can be coupled to a pump (not shown), and can have electronics configured to vary the voltage or frequency of electric power outputted to the pump and thereby control the output of the pump, such as by using a variable frequency drive.

First 110 and second docking stations 112 can also each include first and second electronics 122 and 124 configured to allow the docking stations 110 and 112 to communicate information over the power grid 100. Such electronics can include a network interface to provide for an IP over power line connection or an X10 module electronic coupled to at least one of the docking stations 110 and 112. In addition, at least the first electronics 122 can also be configured to allow the docking stations to communicate information wirelessly. For example, the information can include the signal itself, the time and date of the reading, and location information of the sensor, and the docking station. The information can preferably be communicated with remote monitor 126, which can communicate information and preferably commands to one or more docking stations. Although the first 110 and second docking stations 112 can have networking capabilities, at least one and preferably both of the docking stations 110 and 112 can be independently operable with respect to one another.

In addition to being powered by the power grid 100, or alternatively, any of the docking stations 110 and 112, electronic actuators 118 and 120, and the sensors 106 and 108 can be battery powered.

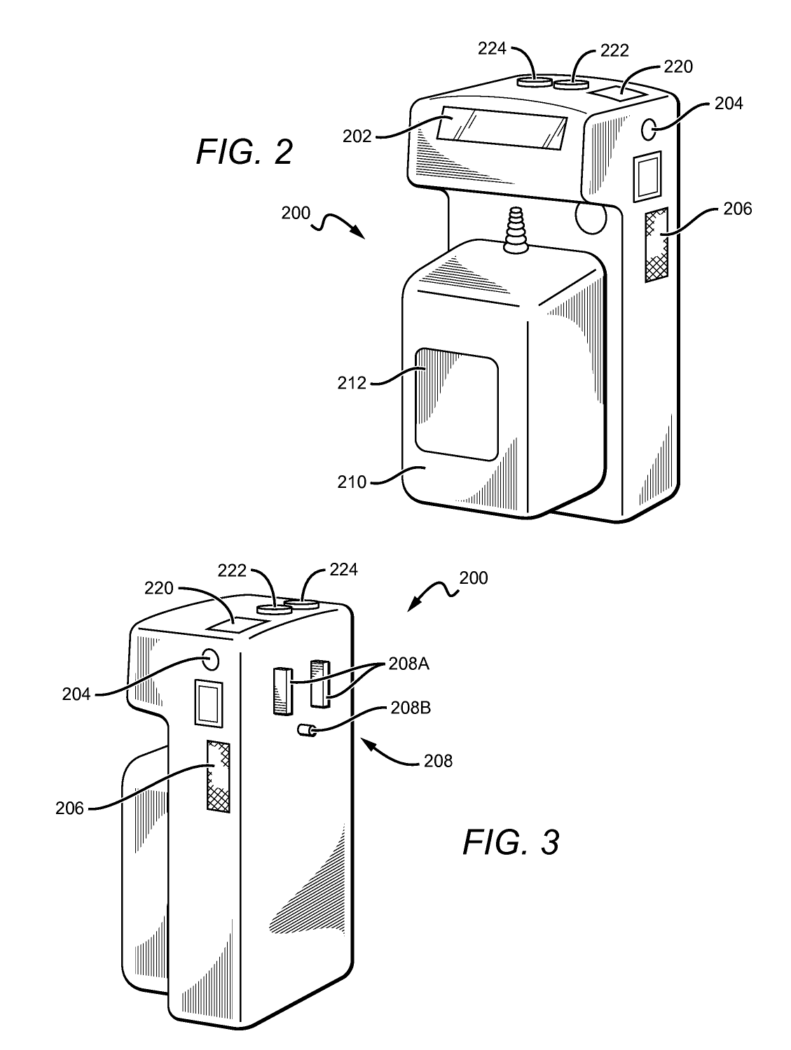

FIGS. 2 and 3 illustrate front and rear views, respectively, of a docking station. Turning to FIG. 2, the docking station 200 has a display 202, a light 204, and a speaker 206.

Display 202 preferably is an LCD display, although organic LEDs displays or other commercially suitable displays are contemplated. The display 202 can be of any practical size and shape to allow information to be read from the display 202. Display 202 can display textual or graphical information, which could include, for example, the status of the docking station 200, or the he coupled valves and sensors.

In addition to display 202, docking station 200 can have a light 204 and a speaker 206 to indicate a status or problem with the docking station or coupled components. For example, the light 204 could be illuminated or caused to blink to indicate a problem. In addition, two or more lights can be used that produce different colors of light to indicate additional information to a user. In a similar manner, an audible alarm could be outputted through speaker 206 to indicate a problem to a user, including for example, a low battery, a power outage, no readings from the sensor, and so forth.

The docking station 200 can include data ports 220, 222, and 224 such that the docking station 200 can be coupled to one or more network connections, valve actuators, sensors, and remote monitors, for example.

Turning to FIG. 3, the docking station 200 can have a power connector 208 to allow the docking station to be pluggable into a standard power outlet (not shown) and thus the power grid. Although the power connector 208 is shown as a standard NEMA 1-15 connector that mates with a standard U.S. power outlet (not shown), other connectors could be used that are configured to plug into non-U.S. power outlets. For example, the power connector 208 can be a standard plug having two blades 208A and a cylindrical pin 208B, or can have any male or female connector(s) or wire(s) including, for example, two cylindrical pins, three cylindrical pins, three blades, and any other plug configuration. Power connector 208 can be used to power the docking station 200 and electronics (not shown) that allow information to be communicated over the power line (not shown).

The valve connector can also include electronics 210 configured to receive a signal from a sensor (not shown). The electronics 210 can allow the docking station 200 to control a valve (not shown). While preferably such electronics 210 communicate with the sensor and valve over a wired connection, it is contemplated that the electronics 210 could provide for wireless communication with one or both of the valve and sensor.

In addition, docking station 200 can have circuitry 212 configured to detect a loss of power and cause the valve (not shown) to be opened when a power loss is detected. In this manner, the valve can be opened allowing water to flow without requiring the valve to be manually opened. Circuitry 212 can also provide additional functionality, including a time delay feature that allows the valve to remain open for a period of time upon receiving a signal from a motion detector (not shown), such as motion sensor 128 in FIG. 1. Preferably the time delay is a period of at least one minute, and more preferably, the time delay can be lengthened or shortened as desired. For example, a time delay of one minute might be sufficient for a sink, but a time delay of thirty minutes might be needed for a dish washer. While circuitry 212 can detect a loss of power and provide for a time delay function, it is also contemplated that such functionality could be provided by two distinct circuitries.

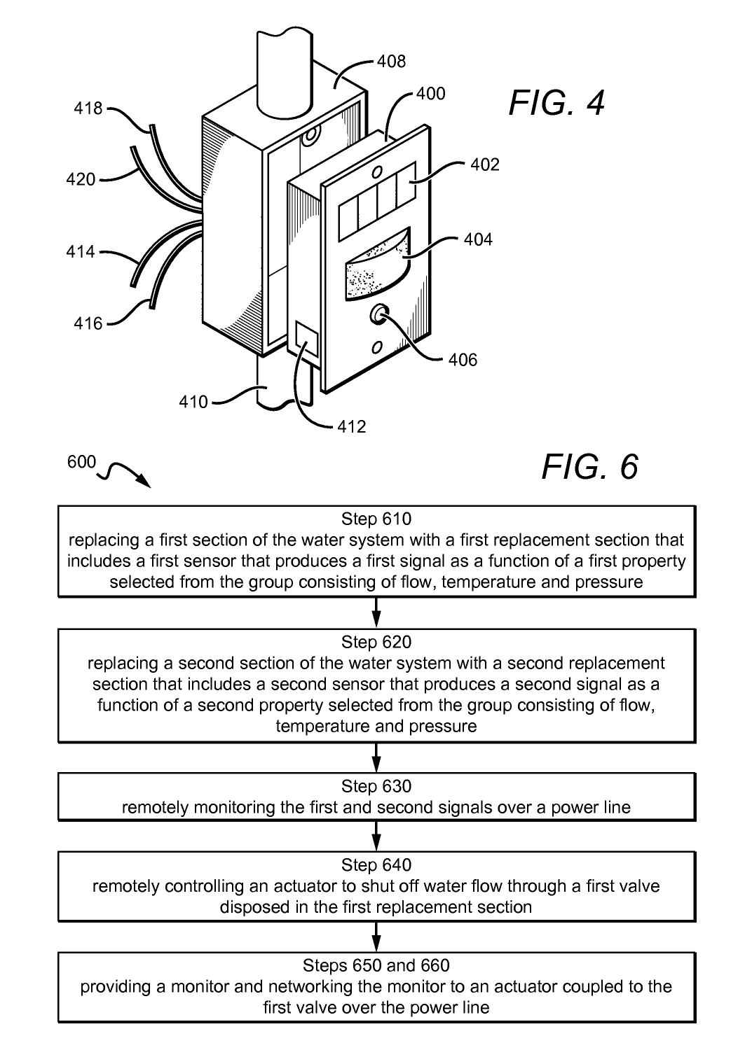

In FIG. 4, an alternate embodiment of a docking station 400 that can be disposed within an electrical box 408 or other housing such that the docking station 400 can be at least partially disposed within a wall or other surface.

The docking station 400 can have a display 402, which can be an LCD display, an organic LED display, or any other commercially suitable display. Display 402 can be of any practical size and shape to allow textual or graphical information to be read from the display 402 including, for example, a status of the docking station 400, a status of a valve or sensor, a status of fluid flow, and so forth. The display advantageously allows a user to be quickly apprised of the status of one or more components coupled to the docking station 400.

Docking station 400 can also include a motion sensor 404 configured to detect a presence of an occupant of the area in which the docking station 400 is situated. Alternatively or additionally, any commercially suitable sensor could be used to detect an occupant's presence including, for example, temperature sensors, infrared sensors, optical sensors, capacitive sensors, proximity sensors, or any combination(s) thereof. Although the motion sensor 404 is shown embedded into the docking station 400, it is contemplated that the motion sensor 404 could be disposed in a separate housing from the docking station 400, and connected to the docking station 400 by a wired or wireless connection.

The docking station 400 can advantageously have a reset switch 406, or other type of actuator, that causes a valve actuator to reset a valve to its default position. Thus, for example, after a problem has been fixed in a water system, a user can actuate the reset switch 406 to return the docking station to an unalarmed state.

The docking station 400 can be coupled to a line voltage or other power source via power cable 410. The docking station can have electronics 412 that allow the docking station 400 to communicate with, and thereby send signals to, a variety of components coupled directly or indirectly to the electrical wiring. Such components could include, for example, valve actuators, other docking stations, sensors, and remote monitors. While preferably electronics 412 are configured such that the docking station 400 can communicate over a wired connection, and preferably electrical wiring, it is contemplated that the electronics 412 could alternatively or additionally provide for wireless communication.

The docking station can optionally be coupled to a network via wired connection 418, although wireless connections are also contemplated. In addition, the docking station 400 can have one or more cables 420 that allow it to send signals directly to a valve actuator (not shown) or other component. Contemplated cables could include, for example, LonWorks® cables or other commercially suitable cables.

The docking station 400 can be coupled to first and second sensors (not shown) via first and second cables 414 and 416.

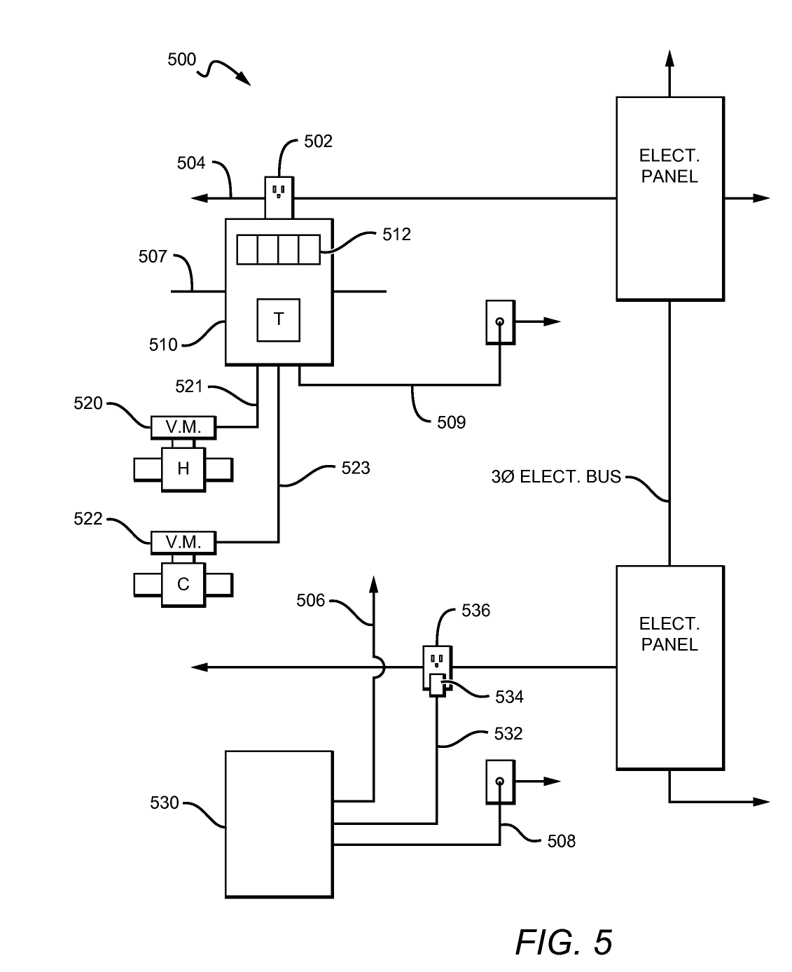

FIG. 5 illustrates an embodiment of a water system 500 having a docking station 510 configured to monitor sensor information and communicate with valve actuators 520 and 522 via wired connections 521 and 523, respectively. Wireless connections are also contemplated.

The docking station 510 can also include a motion sensor 512 or other commercially suitable sensor including those discussed above that is configured to detect a presence of an occupant.

The docking station 510 can be configured to be pluggable into a standard power outlet 502, and thereby be coupled to a structure's electrical wiring 504 such that the docking station 510 can receive power while also communicating information over the electrical wiring 504. For example, the docking station 510 could communicate with remote monitor 530 via X10 communication or other power line communication standards or protocols. Although the docking station 510 can be configured to have a standard NEMA 1-15 connector, the docking station could alternatively have connectors that allow the docking station 510 to be inserted into non-U.S. power outlets.

In some contemplated embodiments, the docking station 510 can be coupled to valve actuators, sensors, remote monitors, or other components of system 500 via data cables 507, Ethernet cables 509, or other commercially suitable wired or wireless connections.

The remote monitor 530 can be coupled to the electrical wiring 504 via cable 532 and power adapter 534, which is plugged into power outlet 536. It is contemplated that the remote monitor can be configured to communicate with multiple valve connectors, sensors, valve actuators, and other components of system 500 via the electrical wiring 504, data cables 506, Ethernet cables 508, and other wired connections. Alternatively or additionally, commercially suitable wireless connections could be used.

FIG. 6 presents a method 600 of retrofitting a water system to reduce risk of water leaks. Initially in step 610, a first section of the water system can be replaced with a first replacement section that includes a first sensor. The first sensor preferably provides a first signal that corresponds to a first property selected from the group consisting of flow, temperature and pressure. In step 620, a second section of the water system is replaced with a second replacement section that includes a second sensor. The second sensor preferably provides a second signal that corresponds to a second property selected from the group consisting of flow, temperature and pressure. In step 630, the first and second signals are remotely monitored over a power line. Once the signals are remotely monitored, an actuator is remotely controlled to shut off water flow through a first valve disposed in the first replacement section in step 640.

When replacing the first or second section, the respective first or second sensors can be included inside or adjacent to the valve (e.g., within 12 inches of the valve). If adjacent to the valve, the step of replacing the section can further comprise including the sensor in a component spaced from the valve by less than 12 inches.

Optionally, a monitor can be provided in step 650, and in step 660, the monitor can be networked to an actuator coupled to the first valve over the power line. It is also contemplated that the same or an additional monitor can be coupled to the second valve over the power line.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system that uses power from a power grid to control first and second fluid valves, comprising:
first and second physically separable sensors that produce respective first and second signals;
a first networked docking station having a first connector, and further having first electronics that processes the first signal;
a second networked docking station having a second connector, and further having second electronics that processes the second signal; and
wherein the first and second networked docking stations are user-pluggable into the power grid.

2. The system of claim 1, wherein the first docking station is independently operable with respect to the second docking station.

3. The system of claim 1, wherein the first and second docking stations are coupled to the first and second fluid valves as part of a permanently installed water system.

4. The system of claim 1, wherein the first docking station further comprises electronics that communicates data over the power grid.

5. The system of claim 1, wherein the first docking station further comprises electronics that communicates data wirelessly.

6. The system of claim 1, further comprising a motion sensor, and the first docking station includes electronics that processes a third signal received from the motion sensor.

7. The system of claim 1, further comprising a monitor that communicates data with the first and second docking stations.

8. The system of claim 1, wherein the first docking station includes a display.

9. The system of claim 1, wherein the first docking station includes a speaker configured to provide an audible alert.

10. The system of claim 1, wherein the first docking station includes at least one light configured to provide a visual alert.

11. The system of claim 1, wherein the first docking station further comprises circuitry that causes the first valve to open upon a loss of power.

12. The system of claim 6, wherein the first docking station further comprises circuitry that causes the first valve to remain open for a period of at least one minute upon receiving the third signal from the motion sensor.

13. The system of claim 1, wherein the first docking station further comprises a compartment sized and dimensioned to receive a battery.

14. A method of retrofitting a water system to monitor and control water consumption, comprising:
replacing a first section of the water system with a first replacement section that includes a first sensor that produces a first signal as a function of a first property selected from the group consisting of flow, temperature and pressure;
replacing a second section of the water system with a second replacement section that includes a second sensor that produces a second signal as a function of a second property selected from the group consisting of flow, temperature and pressure;
remotely monitoring the first and second signals over a power line; and
remotely controlling a valve actuator to shut off water flow through a first valve disposed in the first replacement section.

15. The method of claim 14, wherein the step of replacing the first section comprises including the first sensor inside the first valve.

16. The method of claim 14, wherein the step of replacing the first section comprises including the first sensor in a component adjacent the first valve.

17. The method of claim 14, wherein the step of replacing the first section comprises including the first sensor in a component spaced from the first valve by less than 12 inches.

18. The method of claim 14, further comprising the steps of providing a monitor, and networking the monitor to the valve actuator over the power line.
